(19) United States
(12) Patent Application Publication
(10) Pub. No.: US 2008/0217398 A1
(43) Pub. Date: Sep. 11, 2008

(54) Anti-theft credit card system with a credit card having magnetic stripe containing digitized finger print information of authorized owner and a printing section of user's finger print thereon

(76) Inventor: Keunu Woo, Irvine, CA (US)

Correspondence Address: Eugene Oak, 610 S. Van Ness Ave., Los Angeles, CA, 90005, US

(21) Appl. No.: 11/713,759

(22) Filed: Mar. 5, 2007

(51) Int. Cl. G06K 5/00

(52) U.S. Cl. 235/380

(57) ABSTRACT

An anti-theft credit card system is provided. The anti-theft credit card according to current invention has digitized information of the finger print of an authorized card holder. A finger printing section of a user is provided on a corner of the card. A scanner, installed in a credit card machine, scans the finger print printed on the printing section of the card and send the information to a micro-processor which is installed in the in the credit card machine and digitalize the scanned information. A second micro-processor, which is also installed inside of the credit card machine, compares the newly digitalized fingerprint with the digitized finger print of the authorized owner of the card. If they match each other, the machine proceeds requested procedure. If not, aborts the procedure.

### FIELD OF THE INVENTION

Current application relates to an anti-theft credit card system, which utilize a credit card that has information of the authorized person's digitalized finger print in magnetic stripe and has a printing section of the user's finger print.

### BACKGROUND OF THE INVENTION

Most of stolen credit cards are used within the first few hours of the theft. However, since the cards are usually issued by many different companies, it is unlikely that the fraudulent use of one card will be reported to the issuing companies of the other cards. Because of that, even if one credit card company notices irregular purchases on the credit card and restricts the use of that particular credit or debit card, the fraud continues because the thief simply switches to another credit card in the wallet or purse. Thus, even if the theft is noticed by the cardholder, it is very difficult and time consuming to contact every financial institution. The best way is to provide a credit card that can be used only by the authorized personnel. Secrete code is one of the system that increases security. However, that is not perfect because of a secrete code generator. Another method is to compare the finger print of the card owner when the card is in use. Some of credit cards have digitized fingerprint information of the card owner. But, it is very expensive to produce those known card and the reader for those cards. It is purpose of the current application to provide an anti-theft credit card system with a credit card that has information of the card owner's finger print and finger printing section that is readable by any card machine of current use without severe modification.

### DESCRIPTION OF THE PRIOR ART

U.S. Pat. No. 4,432,567 to Stockburger et al. illustrates an authorization card with one or more storing zones for storing information defining the extent of authorization, for example credit information in the case of a credit card. However, the card is complicated to make and use by a card owner.

U.S. Pat. No. 5,054,090 to Knight et al. illustrates a method and apparatus for parallel processing “live” and “pre-recorded” reference fingerprint data for comparison purposes. U.S. Pat. No. 3,699,519 to Campbell illustrates a method that utilizes a finger from which the fingerprint is directly analyzed.

U.S. Pat. No. 5,255,941 to Solomon illustrates an antifraud credit card assembly includes a card member having first and second faces and a magnetic stripe on the first face and bearing information that is presentable to a sensing machine by a person seeking to consummate a transaction.

U.S. Pat. No. 5,473,144 to Mathurin, Jr. illustrates a credit card having thereon an actual enhanced authorized card holders finger print and corresponding digitized representation of the actual finger print, an apparatus to read the digitized finger print optically and magnetically and a method of reading the finger print optically and magnetically. However, a user must put his/her finger on an additional finger print reader which is installed outside of a credit card machine to authorize transaction. To realize this technology, every credit card machine of current use should be changed.

None of the prior art illustrates an anti-theft credit card system that uses a credit card which has finger print section thereon and contains fingerprint information of the authorized credit card owner to compare those information and to prevents fraud use with minor change of current credit card machines as shown in the current application.

### SUMMARY OF THE INVENTION

Most of stolen credit cards are used within the first few hours of the theft. However, since the cards are usually issued by many different companies, it is unlikely that the fraudulent use of one card will be reported to the issuing companies of the other cards. Because of that, even if one credit card company notices irregular purchases on the credit card and restricts the use of that particular credit or debit card, the fraud continues because the thief simply switches to another credit card in the wallet or purse. Thus, even if the theft is noticed by the cardholder, it is very difficult and time consuming to contact every financial institution. The best way is to provide a credit card that can be used only by the authorized personnel. Secrete code is one of the system that increases security. However, that is not perfect because of a secrete code generator. Another method is to compare the finger print of the card owner when the card is in use. Some of credit cards have digitized fingerprint information of the card owner. But, it is very expensive to produce those known card and the reader for those cards. It is purpose of the current application to provide an anti-theft credit card system with a credit card that has information of the card owner's finger print and finger printing section that is readable by any card machine of current use without severe modification. The anti-theft credit card according to current invention has digitized information of the finger print of an authorized card holder. A finger printing section of a user is provided on a corner of the card. A scanner, inside of a credit card machine, scans the finger print printed on the card and send the information to a micro-processor which is installed in the in the credit card machine and digitalize the scanned information. A second micro-processor, which is also installed inside of the credit card machine, compares the newly digitalized fingerprint with the digitized finger print of the authorized owner of the card. If they match each other, the machine proceeds requested procedure. If not, aborts the procedure.

### BRIEF DESCRIPTION OF THE DRAWING

FIG. 1 is a front view of a credit card according to current invention.

FIG.2 is a rear view of a credit card according to current invention.

FIG. 3 is a schematic drawing of inside of a credit card reader for reading the credit card's information according to current invention.

FIG. 4 is a block diagram of the procedure of authorizing use the credit card according to current invention.

### DETAILED DESCRIPTION OF THE PREFERRED EMBODIMENT

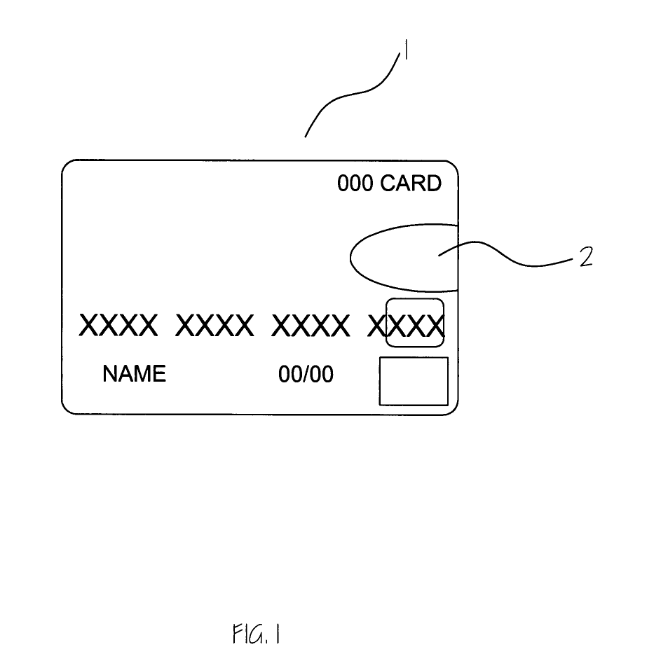

FIG. 1 is a front view of a credit card (1) according to current invention. The card according to current invention has a finger printing section (2) in addition to other information sections. The finger printing section (2) is coated with glass to enhance the mark of finger print. The finger printing section (2) locates on a short side of the front face of the credit card (1). Card holder usually holds the card (1) with thumb finger on the printing section and pushes the card into a cash machine. Then finger print of user is marked on the printing section (2).

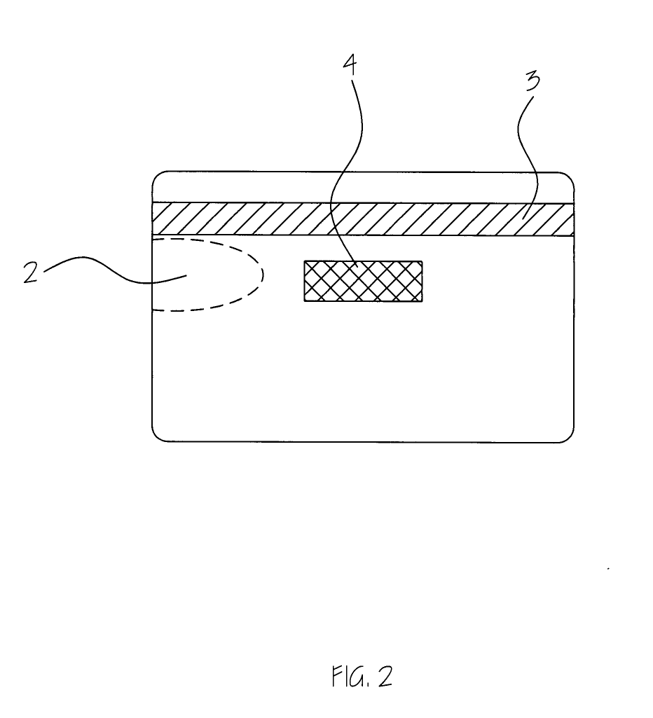

FIG.2 is a rear view of a credit card (1) according to current invention. In addition to first magnetic stripe I (3) that is placed on the rear upper section of the credit card, which has information of card holder, stolen report, and limit of use etc., a second magnetic stripe II (4) is added. Authorized credit card owner's digitized finger print information is stored in the magnetic stripe II (4). The digitized finger print information may be stored in the first magnetic stripe I (3).

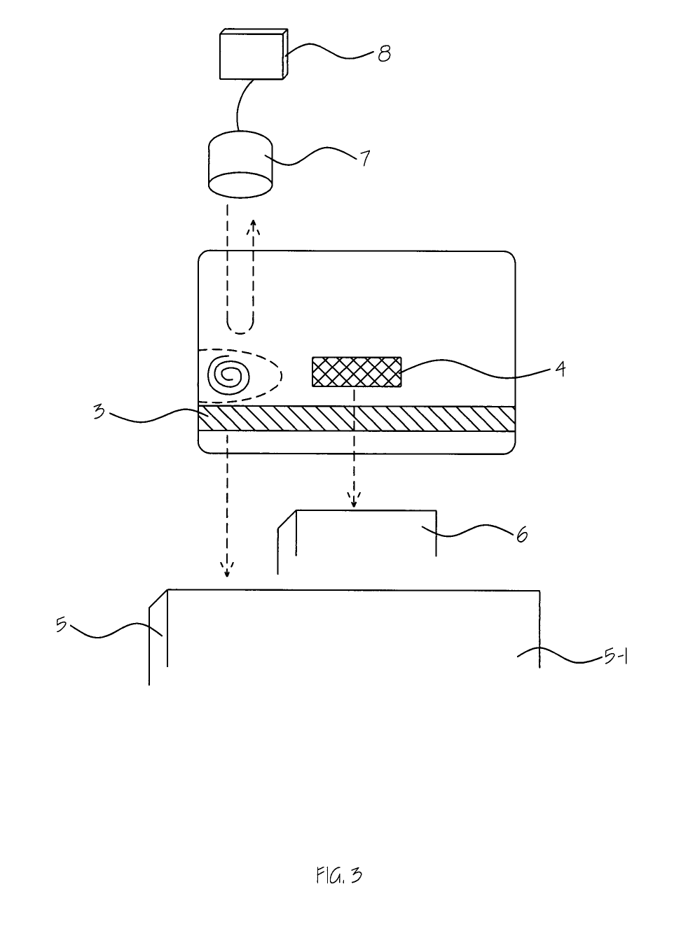

FIG. 3 is a schematic drawing of inside of a credit card reader for reading the credit card's information according to current invention. Usually, first magnetic card reader (5) reads information from the magnetic stripe I (3) and sends it to a first microprocessor (5-1), which is connected to main computer of the credit card (1) issuing company. The first microprocessor (5-1) gathers information from the main computer and check if the credit card (1) is activated and authorized by comparing the information with information from the first magnetic reader (5).

Second magnetic card reader (6) reads digitized finger print information from the magnetic stripe II (4) and sends it to a second microprocessor (8) for further comparison. If the finger print information is stored in the magnetic stripe I (3), the second reader (6) is not needed. An optical finger print reader (7) is installed on the opposite side of the magnetic readers (5), (6). The optical finger print reader (7) emits light beam to the fingerprinting section (2) and read the reflected lights there from. A second microprocessor (8), which is connected to the optical finger print reader (7) and the second magnetic card reader (6), digitize the image of the reflected finger print and compares the information with the digitized finger print information of the authorized owner from the second card reader (6).

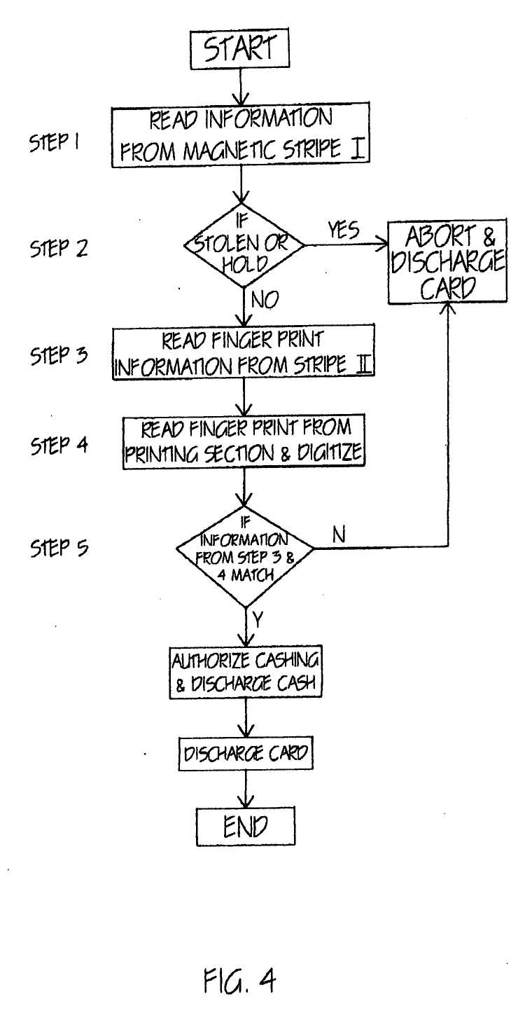

FIG. 4 is a block diagram of the procedure of authorizing use the credit card according to current invention:

Step 1 is to read information from magnetic stripe I (3) of the credit card (1) by the first magnetic reader (5).

In step 2, a first microprocessor (5-1), which is connected to main computer of the credit card (1) issuing company, gather information from the main computer and check if the credit card (1) is activated and authorized by comparing it with information from the first magnetic reader (5).

If the card is hold by any reason, the cash machine discharges the card with “non-approved” sign.

If the card is authorized, then go to step 3.

In step 3, second magnetic reader (6) reads the digitized finger print information of the authorized owner of the credit card (1) from the magnetic stripe II (4). The digitized information is sent to second microprocessor (8) for further comparison. If the digitized finger print information of the authorized owner of the credit card (1) is recorded in the magnetic stripe I (3), another microprocessor (6) is not necessary.

In step 4, the optical finger print reader (7) emits light beam to the fingerprinting section (2) and read the reflected images there from. The second micro processor (8), which is connected to the optical finger print reader (7) and is connected to the second magnetic card reader (6), receives and digitizes the image of the finger print of the current user and compares the result with the digitized information of the authorized credit card owner's finger print received from the second magnetic reader (6).

In step 5, if the stored digital finger print information read from step 3 matches with newly digitized finger prints information, authorize the cashing procedure and discharge cash. After discharging cash, discharge the credit card (1).

If the stored finger print information from step 3 does not match with newly digitized finger print information, discharge the credit card (1) with “non-approved” sign.

Therefore, if a user of the credit card according to current invention is physically different from the authorized owner of the card, the card can not be authorized.

I claim:

1. An anti-theft credit card system containing digitized information of the finger print of an authorized card holder is comprised of:
a credit card which has;
a first magnetic stripe I, which has digitized information of card holder, stolen report, and limit of use, on the rear upper section thereof, and
a second magnetic stripe II, which has digitized finger print information of the authorized owner of the credit card, on the rear middle section thereof, and
a finger printing section of a user that is coated with glass to enhance the mark of finger print and locates on a short side of the front face thereof,
and
a first magnetic card reader that is installed inside of a credit card reader and reads digitized information of the authorized card holder from the first stripe I,
and
a microprocessor, which is connected to main computer of the credit card issuing company, gathers information from the main computer and check if the credit card is activated and authorized by comparing the information with information from the first magnetic card reader,
and
a second magnetic card reader that is installed inside of a credit card reader and reads the digitized finger print information of the authorized card holder from the second magnetic stripe II and send it to a second microprocessor for further comparison,
and
an optical finger print reader, which is installed inside of a credit card reader on the opposite side of the magnetic card readers and scans the finger print printed on the printing section of the credit card,
and
a second microprocessor, which is connected to the optical finger print reader and the second magnetic card reader, digitizes the image of the reflected finger print from the optical finger print reader and compares it with the digitized finger print information of the authorized owner of the credit card from the second magnetic card reader, and proceeds requested procedure if they match each other and abort the procedure if not match.

2. The anti-theft credit card system containing digitized information of the finger print of an authorized card holder of claim 1, wherein;
digitized finger print information of the authorized owner of the credit card is stored in the first magnetic stripe I.
